(19) United States
(12) Patent Application Publication
(10) Pub. No.: US 2017/0043424 A1
(43) Pub. Date: Feb. 16, 2017

(54) PROCESS FOR JOINING METALLIC AND CERAMIC STRUCTURES

(71) Applicant: GENERAL ELECTRIC COMPANY, Schenectady, NY (US)

(72) Inventors: Sundeep Kumar, Bangalore (IN); Eklavya Calla, Bangalore (IN)

(21) Appl. No.: 14/821,850

(22) Filed: Aug. 10, 2015

(51) Int. Cl. B23K 1/19; H01M 10/058; C23C 18/31; C25D 7/00; B23K 1/20; B23K 1/00

(52) U.S. Cl. CPC B23K 1/19; B23K 1/20; B23K 1/0016; C23C 18/31; C25D 7/00; H01M 10/058

(57) ABSTRACT

A method for joining a ceramic component to a metallic component is described. At least one layer of molybdenum is applied to a surface of the ceramic component, by a high-velocity molybdenum wire spray technique. A layer of a nickel-based braze composition is then applied over the molybdenum layer. The braze composition and the ceramic and metallic components are then heated to a sufficient brazing temperature, so as to provide a braze joint between the components. The method can be used to seal an open region of a thermal battery, e.g., a sodium metal halide-based battery.

### TECHNICAL FIELD

This disclosure relates to machines and devices formed from metallic and ceramic components. In some particular embodiments, the invention relates to methods for joining and sealing various structures in the machines or devices, e.g., structures within electrochemical devices.

### BACKGROUND OF THE INVENTION

Many types of machines and devices include components made of diverse materials, such as metals, plastics, and ceramics. Examples include lighting devices; power equipment, e.g., gas turbine engines; pumps used in oil and gas exploration; and medical equipment, such as X-ray devices. As another illustration, electrochemical devices such as batteries and fuel cells include various metal and ceramic structures. These structures often need to be joined to each other—often in a way that provides a seal on or within the particular device. In the case of electrochemical devices, the seals may be used to encapsulate the entire device, or they may separate various chambers within the device. Many types of seal materials have been considered for use in high-temperature rechargeable batteries for joining different components. When the particular structures being joined are ceramic and metal, challenges arise in the joining process.

Sodium/sulfur or sodium/metal halide are good examples of high-temperature electrochemical devices, batteries, that may include a variety of ceramic and metal components. The ceramic components often include an electrically insulating alpha-alumina collar, and an ion-conductive electrolyte beta-alumina tube, and are generally joined or bonded via a sealing glass. The metal components usually include a metallic casing, current collector components, and other metallic components which are often joined by welding or thermal compression bonding (TCB). While mechanisms for sealing these components are currently available, their use can sometimes present some difficulty. For example, metal-to-ceramic bonding can be challenging, due to thermal stress caused by a mismatch in the coefficient of thermal expansion for the ceramic and metal components.

Since metal-to ceramic bonding is most critical for the reliability and safety of the cells for high-temperature batteries, many different types of seal materials and sealing processes have been considered for joining such components, including ceramic adhesives, brazing, and sintering. However, most of the seals may not withstand high temperatures and corrosive environments. A common bonding technique involves multiple steps of metalizing the ceramic component, followed by bonding the metallized ceramic component to the metal component using thermal compression bonding (TCB).

The bond strength of such metal-to-ceramic joints is controlled by a wide range of variables, such as the microstructure of the ceramic component, the metallization of the ceramic component, and various TCB process parameters. In order to ensure good bond strength, the process requires close control of several parameters involved in various process steps. In short, the method is relatively expensive, and complicated, in view of the multiple processing steps, and the difficulty in controlling the processing steps.

In some instances, metallization of a ceramic surface for bonding with a metal component involves the use of molybdenum or molybdenum/manganese-based inks, as described in “Zebra Electric Energy Storage system: From R&D to Market”, Renato Manzoni et al, HTE hi.tech.expo—Milan 25-28 Nov. 2008 (website record). In a typical process, the ink or paste is formulated with various alcohols, amines, and alkanes, along with binder materials. (Various other components may also be present, e.g., ether esters, aromatic compounds, and functionalized silanes). The inks are often screen-printed on top of the ceramic, effectively metallizing the component. The component is then heat-treated in a fairly complicated process, at temperatures in the range of about 1500-1650° C., to provide a dense, sintered metallization layer. The ceramic can then be clamped to an appropriate metal component, e.g., a nickel ring for a battery cell, followed by heating in a kiln or other suitable furnace to join the parts by a TCB technique.

While the metallization process described above can be useful in some types of applications, it has some disadvantages. For example, the process is sensitive to various factors, and can be cost-intensive. Such a process includes a number of variables that need to be controlled to obtain ideal properties in the metallization layer. In a manufacturing environment, this type of process tends to drift from its optimum settings, producing components which are out-of-specification.

With these considerations in mind, new types of sealing structures and compositions for many different types of articles and devices that include ceramic and metal structures would be welcome in the art. In the case of electrochemical devices, the new technology should provide hermetic sealing with a joint strength sufficient to meet rigorous end use requirements for the electrochemical cells. Moreover, the overall sealing structure should be compatible with electrochemical cell contents that might come into contact with the seals. It would also be desirable if the sealing structures can be obtained with relatively low fabrication costs, e.g., as compared to some of the metallization/TCB processes used in conventional situations. Similar requirements for other articles and equipment could benefit from the same type of new developments.

### BRIEF DESCRIPTION OF THE INVENTION

One embodiment of the invention is directed to a method for joining a ceramic component to a metallic component. The method comprises the following steps:

a) applying at least one layer of molybdenum to a surface of the ceramic component, by a high-velocity molybdenum wire spray technique;

b) applying at least one layer of a nickel-based braze composition over the molybdenum layer; and

c) heating the braze composition and the ceramic and metallic components to a sufficient brazing temperature, so as to provide a braze joint between them.

Another embodiment is directed to a method of sealing an open region of a sodium metal halide-based battery that includes

(I) an anodic chamber for containing an anodic material; and a cathodic chamber for containing a cathodic material, separated from each other by an electrolyte separator tube, all contained within a case for the cell;

(II) an electrically insulating ceramic collar positioned at or near an opening of the cathodic chamber, and defining an aperture in communication with the opening; and

(III) a cathode current collector assembly disposed within the cathode chamber. The method comprises the steps of
(i) inserting at least one metal ring between at least a portion of the cathode current collector assembly and an adjacent portion of the ceramic collar;
(ii) applying at least one layer of molybdenum to a surface of the ceramic component, by a high-velocity molybdenum wire spray technique;
(iii) applying at least one layer of a nickel-based braze composition over the molybdenum layer; and
(iv) heating the braze composition to a sufficient brazing temperature, so as to provide, upon cooling, a hermetic seal between the metal ring, the current collector assembly, and the adjacent portion of the ceramic collar.

### BRIEF DESCRIPTION OF DRAWINGS

FIG. 1 is a simplified illustration of an exemplary molybdenum wire spray system.

FIG. 2 is a schematic view showing a cross-section of an electrochemical cell that can be manufactured according to some embodiments of this invention.

FIG. 3 is a photograph of an inner ring used in the sealing region of an electrochemical cell.

FIG. 4 is a photograph of an outer ring used in the sealing region of an electrochemical cell.

FIG. 5 is a photograph of a prefabricated braze preform.

FIG. 6 is a perspective view of a joining structure for the sealing region of an electrochemical cell.

FIG. 7 is another depiction of the sealing region of an electrochemical cell, depicting a portion of the top end of an alpha alumina collar.

FIG. 8 is a photomicrograph of a cross-section of an alpha alumina collar in a sealing region of an electrochemical cell, mounted on an epoxy plate for SEM (scanning electron microscope) analysis.

FIG. 9 is a photograph of a brazed structure in the sealing region of an electrochemical cell, showing a ceramic-metal seal.

FIG. 10 is a cross-sectional scanning electron micrograph of a portion of the brazed structure of FIG. 9.

FIG. 11 a photograph of a number of brazed structures, similar to those of FIG. 9.

### DETAILED DESCRIPTION OF THE INVENTION

A number of preliminary points may be helpful. When introducing elements of various embodiments of the present invention, the articles “a,” “an,” “the,” and “said” are intended to mean that there are one or more of the elements, unless otherwise indicated. The terms “comprising,” “including,” and “having” are intended to be inclusive, and mean that there may be additional elements other than the listed elements. As used herein, the term “and/or” includes any and all combinations of one or more of the associated listed items. Unless otherwise indicated herein, the terms “disposed on”, “deposited on” or “disposed between” refer to both direct contact between layers, objects, and the like, or indirect contact, e.g., having intervening layers therebetween.

Approximating language, as used herein throughout the specification and claims, may be applied to modify any quantitative representation that could permissibly vary, without resulting in a change in the basic function to which it may be related. Accordingly, a value modified by a term such as “about” is not limited to the precise value specified. In some instances, the approximating language may correspond to the precision of an instrument for measuring the value.

A brief description of some of the terms used in this disclosure would be helpful. As used herein, the term “liquidus temperature” generally refers to a temperature at which an alloy is transformed from a solid into a molten or viscous state. The liquidus temperature specifies the maximum temperature at which crystals can co-exist with the melt in thermodynamic equilibrium. Above the liquidus temperature, the alloy is homogeneous, and below the liquidus temperature, an increasing number of crystals begin to form in the melt with time, depending on the particular alloy. Generally, an alloy, at its liquidus temperature, melts and forms a seal between two components to be joined.

The liquidus temperature can be contrasted with a “solidus temperature”. The solidus temperature quantifies the point at which a material completely solidifies (crystallizes). The liquidus and solidus temperatures do not necessarily align or overlap. If a gap exists between the liquidus and solidus temperatures, then within that gap, the material consists of solid and liquid phases simultaneously (like a “slurry”).

“Sealing” is a function performed by a structure that joins other structures together, to reduce or prevent leakage through the joint between the other structures. The seal structure (e.g., various collar and ring structures as exemplified herein) may also be referred to as a “seal” or “joint” herein, for the sake of simplicity. In the present instance, the ceramic and metal components that can be sealed to each other are sometimes part of at least one thermal battery structure selected from the group consisting of electrode compartments; sealing collar structures, sealing ring structures, and electrical current collectors, as further described below.

Typically, “brazing” uses a braze material (usually an alloy) having a lower liquidus temperature than the melting points of the components (i.e. their materials) to be joined. The braze material is brought slightly above its melting (or liquidus) temperature while protected by a suitable atmosphere. The braze material then flows over the components (known as wetting), and is then cooled to join the components together.

As used herein, “braze alloy composition” or “braze alloy”, “braze material” or “brazing alloy”, refers to a composition that has the ability to wet the components to be joined, and to seal them. A braze alloy, for a particular application, should withstand the service conditions required, and should melt at a lower temperature than the base materials; or should melt at a very specific temperature. Conventional braze alloys usually do not wet ceramic surfaces sufficiently to form a strong bond at the interface of a joint. In addition, the alloys may be prone to sodium and halide corrosion, when these types of materials are present within a structure to be brazed.

As used herein, the term “brazing temperature” refers to a temperature to which a brazing structure is heated to enable a braze alloy to wet the components to be joined, and to form a braze joint or seal. The brazing temperature is often higher than or equal to the liquidus temperature of the braze alloy. In addition, the brazing temperature should be lower than the temperature at which the components to be joined may become chemically, compositionally, and mechanically unstable. There may be several other factors that influence the brazing temperature selection, as those skilled in the art understand.

A variety of ceramic materials can be used in embodiments of this invention. Non-limiting examples include zirconia-based materials, alumina, aluminum nitride, silicon carbide, porcelain, titanium carbide, silica (e.g., glass), ceramic matrix composites (CMC's), magnesium aluminate spinel, magnesium oxide, and silicon nitride, as well as many alloys of such materials.

Moreover, the metallic component for embodiments of this invention can also comprise a wide variety of metals and alloys, depending on the end use of the article. Non-limiting examples include nickel, iron, niobium, molybdenum, a nickel-cobalt ferrous alloy; mild steel, stainless steel, tungsten, and various combinations of any of the foregoing.

As mentioned above, at least one layer of molybdenum is applied to a designated surface of the ceramic component to be joined to the metal component. Usually, the molybdenum is very pure, e.g., 99% pure, and in some cases, 99.9% pure. As further described below, molybdenum applied by way of the present invention can provide an ideal surface for a subsequent brazing process.

A high-velocity molybdenum wire spray technique is used to apply the molybdenum to the ceramic surface (i.e., the portion of the surface designated for joining to the metallic component). In some cases, the ceramic surface is cleaned and roughened, prior to molybdenum deposition). The molybdenum wire spray technique, sometimes referred to as “wire flame spray”, is generally known in the art, and described in a number of references. As an example, the technique is generally described in “A Study of High-Velocity Combustion Wire Molybdenum Coatings”, by S. C. Modi and Eklavya Calla, Journal of Thermal Spray Technology, JTTEE5 10, pp. 480-486, September 2001. The contents of this article are incorporated herein by reference.

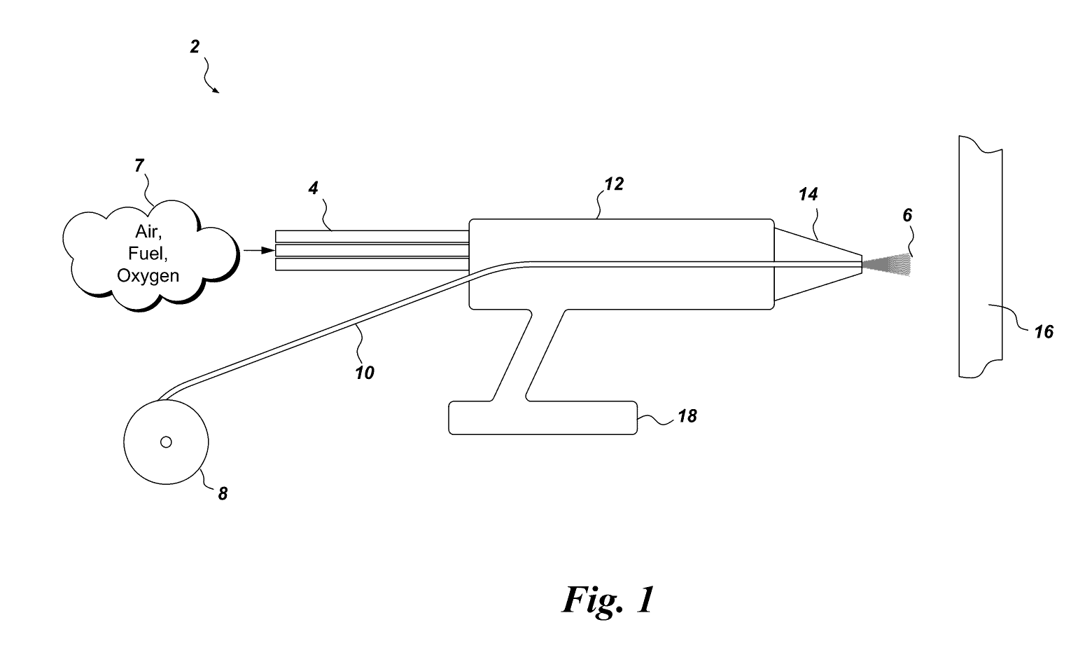

An exemplary molybdenum wire spray system is illustrated in FIG. 1. The apparatus 2 includes one or more inlets (e.g., hoses) 4 for supplying gases used to support combustion flame 6. Three inlet conduits are illustrated, but that number can vary.

Usually, the combustion flame is formed by the ignition of a gas mixture 7 that comprises oxygen and at least one hydrocarbon gas. Non-limiting examples of the hydrocarbon gas include acetylene, propane, propylene, and liquefied petroleum gas (LPG). Hydrogen can also be used as the fuel gas. Moreover, air is often used to participate, along with the fuel and oxygen, in atomizing the liquid droplets of molybdenum.

Molybdenum can be supplied in a number of ways, e.g., via wire spool 8. The molybdenum feedstock can be fed by any suitable wire feed mechanism 10, to spray gun 12. The feed rate for the molybdenum wire will depend on a number of factors, such as the amount of molybdenum required for the ceramic surface; the combustion flame temperature used to melt the molybdenum wire, the type of spray gun 12; and the diameter of the molybdenum wire (often about 1-5 mm). In some cases, the feed rate will be in the range of about 10 g/minute to about 30 g/minute. Slower feed rates within this range can be used to create finer deposits. The factors set forth above can be adjusted to provide a composition for the deposited layer of molybdenum that comprises about 10 wt % to about 30 wt % molybdenum oxides.

The particular type of spray gun 12 that is used can vary. As those skilled in the art understand, spray guns used in thermal spray processes such as HVOF can be employed and appropriately modified, if necessary. The distance between the spray gun exit 14 and the molybdenum substrate surface 16 can also vary according to some of the factors mentioned above, but is usually between about 25 mm and 500 mm. (The spray apparatus may include other features as well, e.g., a mounting mechanism 18 for hand-held or robotic control; as well as any type of general computer control (not shown), e.g., computer numerical control/CNC systems).

The ignition of the combustion gases 7 provides the temperature necessary to melt the molybdenum, usually about 2,600° C. to about 4,000° C. The combustion flame itself must be hot enough to achieve melting of the wire tip. The molten molybdenum, in droplet form (e.g., atomized, liquid droplets), is accelerated toward the surface of substrate 16, often at a speed in the range of about 200 m/s to 800 m/s. The molybdenum can be thought of as mechanically attaching to the substrate, solidifying to form a solid, adherent layer. The thickness of the layer will depend in part on the type of ceramic structure being coated; the type of metal component being joined thereto, and the article/device in which the joined structure is incorporated. In the case of the electrochemical cell structures, the thickness will usually be in the range of about 1 micron to about 50 microns; and preferably, in the range of about 15 microns to about 40 microns. As noted previously, the molybdenum layer provides an effective foundational site for subsequent braze deposition.

In some embodiments, a layer of nickel is applied over the molybdenum layer, prior to application of the braze composition. The nickel layer can be advantageous in enhancing both the hermeticity and the strength of the subsequently-formed braze joint. This is due, in part, to the ability to prevent mechanical degradation of the molybdenum layer, and allowing the braze alloy to wet the metallization layer completely.

A number of different techniques can be used to apply the nickel layer. Non-limiting examples include electroplating, electroless plating, and screen-printing. The nickel layer thickness is dependent on several factors, such as bath chemistry, bath temperature (in the case of electroplating and electroless plating); and the voltage applied (in the case of electroplating). In the case of screen-printing, other factors are ink viscosity; and screen size. In the case of structures for electrochemical cells, the thickness is usually about 1 to about 20 microns, and in some cases, about 2 to about 15 microns.

As mentioned above, at least one layer of a nickel-based braze composition is applied over the molybdenum layer—directly, or over an intervening nickel layer. Many of the braze alloy compositions useful for the present invention contain nickel, and further comprise a) germanium, b) niobium and/or chromium, or c) silicon and/or boron. The composition is often “nickel-based”, i.e., containing about 30% or more nickel, by weight, and in some instances, containing at least about 50% nickel. These braze compositions may further include other alloying elements, such as cobalt and iron. Alternatively, the braze alloy composition may comprise copper and nickel. Each of the elements of the alloy contributes to at least one property of the overall braze composition, such as liquidus temperature, coefficient of thermal expansion, flowability or wettability of the braze alloy with a ceramic; and corrosion resistance.

A number of different techniques can be used to apply the braze material, including techniques that might be employed to deposit the optional, underlying nickel layer, described above. Thus, examples include electroplating, electroless plating, and screen-printing. In some instances, a cold spray technique could be employed, as described in pending application Ser. No. 14/572,216 (S. Kumar et al), filed on Dec. 16, 2014, and incorporated herein by reference. As mentioned previously, the braze material could be applied in multiple layers, in some embodiments. Moreover, in some embodiments, a prefabricated braze “preform” can be used, as noted below.

The overall thickness of the braze layer/structure (i.e., one or more layers) will also depend on various factors. They include the particular composition of the braze; and the shape and size of the components being joined. Usually, the braze thickness, after cooling and solidification, is in the range of about 5 microns to about 100 microns. In preferred embodiments, especially in the case of sodium metal halide batteries (discussed below), the thickness is in the range of about 10 microns to about 75 microns. (It should be noted that at least some of the braze composition could be applied to the surface of the metal component being joined to the ceramic component, prior to brazing).

After the braze composition is applied, the ceramic component can be positioned and attached to a selected surface of the metal structure. An illustration is provided, for example, in application Ser. No. 14/572,216. The two components can temporarily be held in place with an assembly (e.g., a clamp), or by other techniques, until brazing is complete.

The specific details of the brazing step are known in the art. The joined ceramic-metal structure having the braze composition therebetween is heated to an appropriate brazing temperature, and the braze alloy melts and flows over the joining surfaces. The heating can be undertaken in a controlled atmosphere, such as ultra-high pure argon, hydrogen and argon, ultra-high pure helium; or in a vacuum. To achieve good flow and wetting of the braze alloy, the brazing structure is held at the brazing temperature for a selected period, e.g., a few minutes after melting of the braze alloy. This period may be referred to as the “brazing time”.

The brazing temperature and the brazing time may influence the quality of the braze seal. The brazing temperature is generally less than the melting temperatures of the components to be joined, and higher than the liquidus temperature of the braze alloy. In one embodiment, the brazing temperature ranges from about 900° C. to about 1500° C., for a time period of about 1 minute to about 30 minutes. In a specific, non-limiting embodiment, the heating is carried out at the brazing temperature from about 1000° C. to about 1300° C., for about 5 minutes to about 15 minutes.

During brazing, the alloy melts and flows between the metal surface and the coated ceramic surface, forming an interface therebetween. In a typical sequence, the brazing structure is then subsequently cooled to room temperature; with the resulting braze seal between the two components. In some instances, rapid cooling of the brazing structure is permitted. Those of ordinary skill in the art will be able to modify the processes described herein, to accommodate a variety of different factors and end use applications.

As mentioned above, ceramic and metal components that need to be joined together are present in a large number of instruments, machines, structures, and devices. Non-limiting examples include lighting devices, automobile parts; and frame-sections and other structures within buildings, e.g., heating and ventilation systems. Other examples include power equipment, e.g., gas turbine engines; as well as pumps, motors, and compressors used in oil and gas exploration. Medical equipment may also include various ceramic and metal structures that also need to be joined with a relatively high degree of joint integrity. An exemplary medical device of this type is an X-ray device.

Another embodiment for this invention relates to joining processes for various energy storage devices. These devices often include sealing systems in which device components must be hermetically sealed to each other. The sodium-based battery cells (mentioned above) that benefit greatly from these inventive concepts are known in the art, and are usually of the sodium metal halide- or sodium-sulfur type. Many details regarding some of these types of devices are provided, for example, in U.S. patent application Ser. No. 13/407,870, filed Feb. 29, 2012; Ser. No. 13/538,203, filed Jun. 29, 2012; Ser. No. 13/600,333, filed Aug. 31, 2012; and Ser. No. 13/628,548, filed Sep. 27, 2012; as well as U.S. Pat. No. 8,757,471, all of which are expressly incorporated herein by reference, in their entirety.

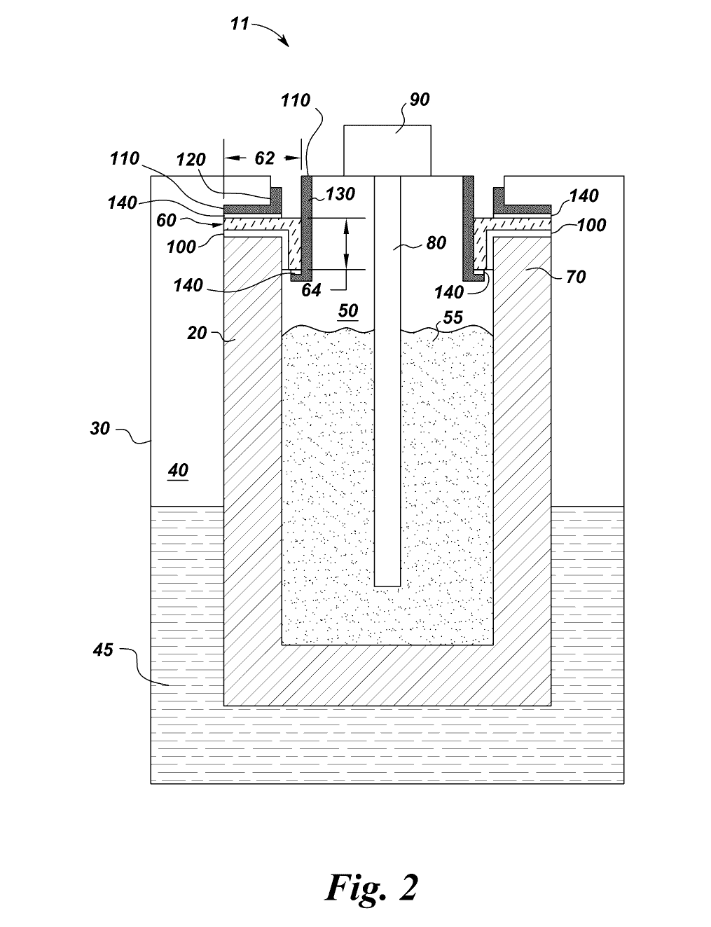

FIG. 2 is a schematic diagram depicting an exemplary embodiment of a sodium-metal halide battery cell 11. The cell 11 has an ion-conductive separator tube 20 disposed in a cell case 30 (usually the outer structure of the cell). The separator tube 20 is usually made of beta (β) alumina, and preferably, beta″-alumina (beta double prime alumina). The tube 20 defines an anodic chamber 40 between the cell case 30 and the tube 20, and a cathodic chamber 50, inside the tube 20. The anodic chamber 40 is usually filled with an anodic material 45, e.g. sodium. The cathodic chamber 50 contains a cathode material 55 (e.g. nickel and sodium chloride), and a molten electrolyte, usually sodium chloroaluminate (NaAlCl₄), along with some other additives.

An electrically insulating collar 60, which may be made of alpha-alumina or spinel, is situated at a top end 70 of the tube 20. A cathode current collector assembly 80 is often disposed in the cathode chamber 50, with a cap structure 90, in the top region of the cell (i.e., the open region). In this exemplary embodiment, the collar 60 is fitted onto the top end 70 of the separator tube 20, and is sealed by a glass seal 100 in an existing battery design. In one embodiment, the collar 60 includes an upper portion 62, and a lower inner portion 64 that abuts against an inner wall of the tube 20 through glass seal 100, as illustrated in FIG. 2.

In order to seal the cell 11 at the top end (i.e., its upper region), and to ensure that the anode and cathode are chemically and physically separate from each other, and separated from the collar 60 in the corrosive environment, at least one ring is employed. Thus, ring 110, made of metal or a metal alloy, is disposed, covering the collar 60, and joining the collar with the current collector assembly 80 (extending upwardly and outwardly), at the cap structure 90. While a single ring 110 may be used, including two portions, two separate rings are more often employed. Thus, an outer ring 120 and an inner ring 130 can be joined, respectively, with the upper portion 62 and the lower portion 64 of the collar 60, by means of the braze seal 140. The outer ring contacts at least a portion of the ceramic collar and an adjacent portion of the cell case, through the braze material described herein. The inner ring usually contacts at least a portion of the cathode current collector assembly and an adjacent portion of the collar. The braze seal 140 is provided by the braze alloy composition described above. Moreover, the overall thickness of the braze layer/structure (i.e., one or more layers) will also depend on various factors. They include the particular composition of the braze; and the shape and size of the component.

The outer ring 120 and the inner ring 130 are usually welded shut to seal the cell, after joining with the collar 60 is completed. The outer ring 120 can be welded to the cell case 30; and the inner ring 130 can be welded to the current collector assembly 80.

The shapes and size of the several components discussed above with reference to FIG. 2 are only illustrative for the understanding of the cell structure; and are not meant to limit the scope of the invention. The exact position of the seals and the joined components can vary to some degree. Moreover, each of the terms “collar” and “ring” is meant to comprise metal or ceramic parts of circular or polygonal shape, and in general, all shapes that are compatible with a particular cell design.

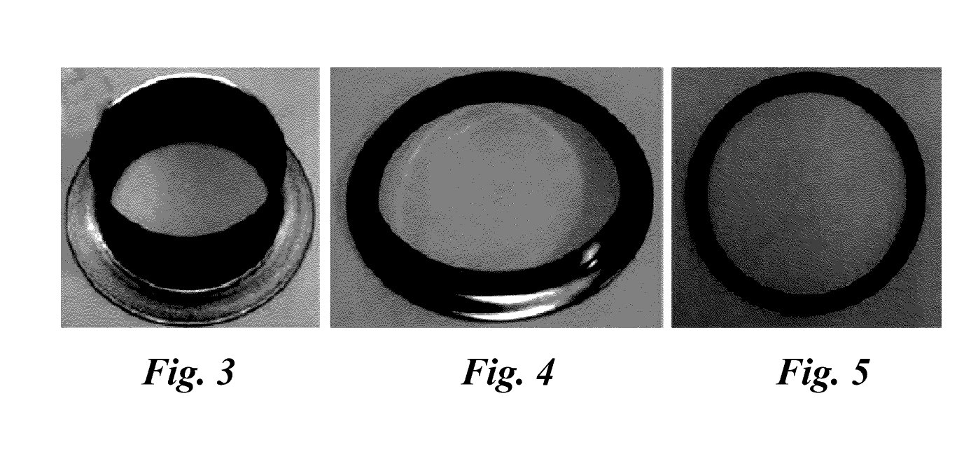

FIGS. 3 and 4 are photographs of typical inner and outer metal rings, respectively, here each formed of nickel. These metal rings are very suitable for the type of device shown in FIG. 2. However, the shape, size, and material forming each ring can vary considerably, depending on the particular type of device into which they are incorporated.

FIG. 5 is a photograph of a prefabricated braze preform, as described above. The use of a pre-form, rather than spraying or otherwise applying braze material to a component surface immediately before heating, is sometimes desirable. As an example, pre-forms are very useful in high-speed manufacturing processes. They can also desirably eliminate the need for using binders and solvents in a manufacturing facility.

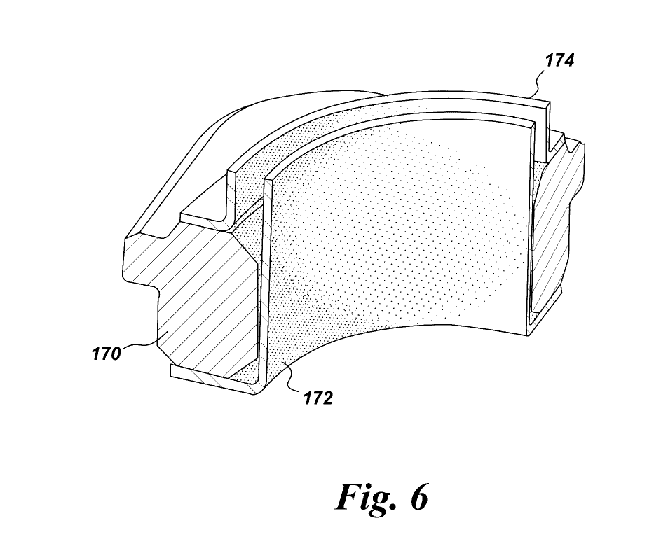

FIG. 6 represents another perspective of a typical joining structure that would be suitable for the device shown in FIG. 2, e.g., in the upper sealing region of a high-temperature battery. Thus, an alpha-alumina collar 170 is at least partially surrounded by nickel inner ring 172 and nickel outer ring 174. As exemplified above, the outer ring can join the collar to an adjacent portion of the cell case (not shown here), while the inner ring can join another portion of the collar to an adjacent section of a current collector (not shown). Other sealing configurations are possible as well, and are within the scope of this disclosure.

As is apparent from this description, the various metallic components in the device of FIG. 2 can be attached to adjacent ceramic components by a process that involves, in part, the use of the high-velocity molybdenum wire spray technique. The present inventors discovered significant advantages in using these techniques, as compared to the prior art techniques alluded to previously. The deposition steps include the high-velocity wire spray deposition of molybdenum, followed by the application of a suitable nickel-based braze composition. For one of the specific regions of a battery cell noted above, the outer metal ring of the cell structure contacts at least a portion of the surrounding ceramic collar and an adjacent portion of the battery cell case, through the solidified braze material.

### EXAMPLES

The following examples illustrate methods and embodiments in accordance with the invention. Unless specified otherwise, all ingredients may be commercially available from such common chemical suppliers as Alpha Aesar, Inc. (Ward Hill, Mass.), Sigma Aldrich (St. Louis, Mo.), Spectrum Chemical Mfg. Corp. (Gardena, Calif.), and the like.

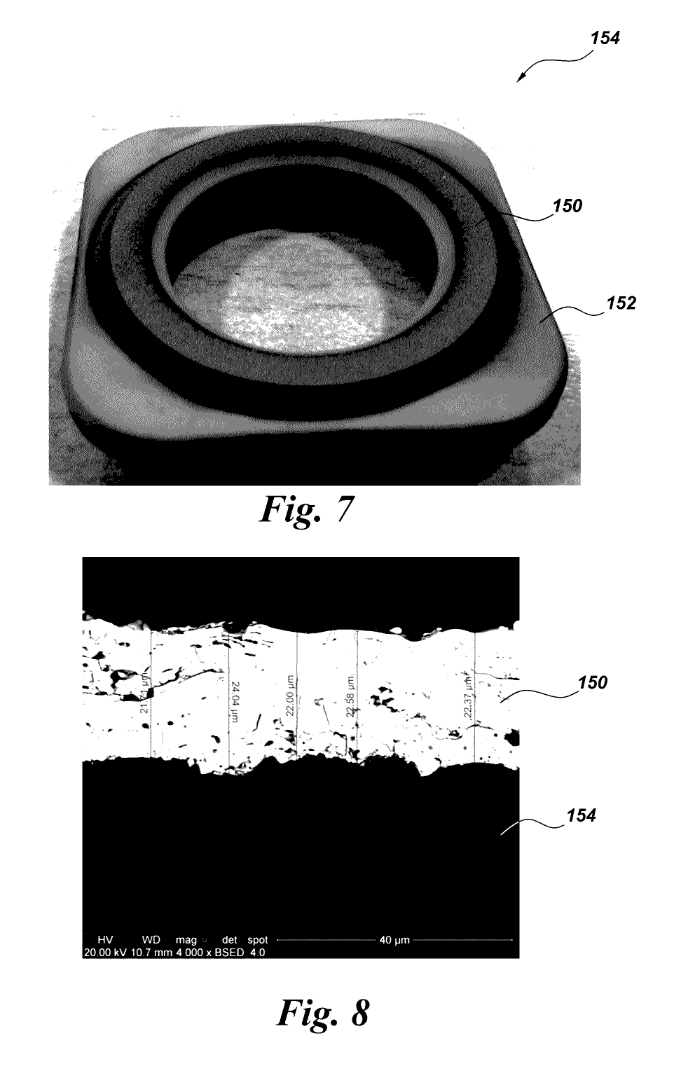

A layer 150 of molybdenum was applied to the landing area 152 at the top end of an alpha alumina collar 154 used for a battery cell, as illustrated in FIG. 7. The molybdenum layer was applied to surface 152, using the high-velocity combustion wire (HVCW) spray technique described above. The following wire spray parameters were used, based in large part on the parameters set forth in the reference described above, authored by S. C. Modi and Eklavya Calla. (Tables 1, 2 and 3 below):

TABLE 1
COMPOSITION OF
LIQUEFIED PETROLEUM
GAS FOR SPRAY SYSTEM

| | |
|---|---|
| Ethane | 00.90 wt % |
| Propane | 28.40 wt % |
| Iso-butane | 30.20 wt % |
| N-butane | 40.50 wt % |

TABLE 2
HVCW PARAMETERS FOR
SPRAYING MOLYBDENUM

| Parameter | Pressure | Flow Meter Reading |
|---|---|---|
| Oxygen | 6.0 kg/Cm² | 90 (11.81 M³/h) |
| LPG | 6.0 kg/Cm²³ | 55 (3.41 M³/h) |
| Air | 6.0 kg/Cm² | |

TABLE 3
MOLYBDENUM SPRAY PARAMETERS

| Parameter | Round 1 | | Round 2 | | Round 3 | |
|---|---|---|---|---|---|---|
| Wire Feed Rate | 11.0 | cm/min | 25.0 | cm/min | 25.0 | cm/min |
| Gun-to-Substrate | 1500 | mm | 1500 | mm | 800 | mm |
| (Distance) | | | | | | |

The thickness of the molybdenum layer was about 50 microns. As mentioned above, the collar would typically be fitted into the top end of a separator tube/electrolyte, by the use of a glass seal. Examples of the general design are depicted in some of the figures described below.

FIG. 8 is a cross-section of the alpha alumina collar 154, mounted on an epoxy plate for SEM (scanning electron microscope) analysis. The magnified cross-section shows the molybdenum layer 150, measured in depth (e.g., about 254 microns in some sections), overlying alumina collar 154. The molybdenum layer had a density as high as about 95%, and had only about 5% porosity. Such a layer does not require any glass in the underlying ceramic region, and this is in contrast with the metallization processes often practiced in the prior art. (In those instances, glass would typically fill the pores of the metallization layer).

The dense layer is in advantageous contrast to a typical, screen-printed layer, where the porosity in a sintered metallization layer can be as high as 40%. Such a high porosity requires the underlying ceramic structure to include a glassy phase, which on sintering, wicks into the porous metallization layer. Moreover, the solvents that are needed for a screen-printing process are also the source of pores and leaks in the coating, with high temperatures being required to treat the deposited layer.

In the present instance, the molybdenum layer is relatively thick and dense. Moreover, the layer has very good adhesion to the underlying alumina surface. As noted above, these are distinct advantages for the subsequent brazing process. This new method of metallization is independent of the underlying ceramic composition, e.g., independent of the presence or absence of a glassy phase. This can be a considerable benefit, eliminating process and compositional variables such as underlying ceramic grain size, the proportion of glassy phase content; and the glassy phase mean free path.

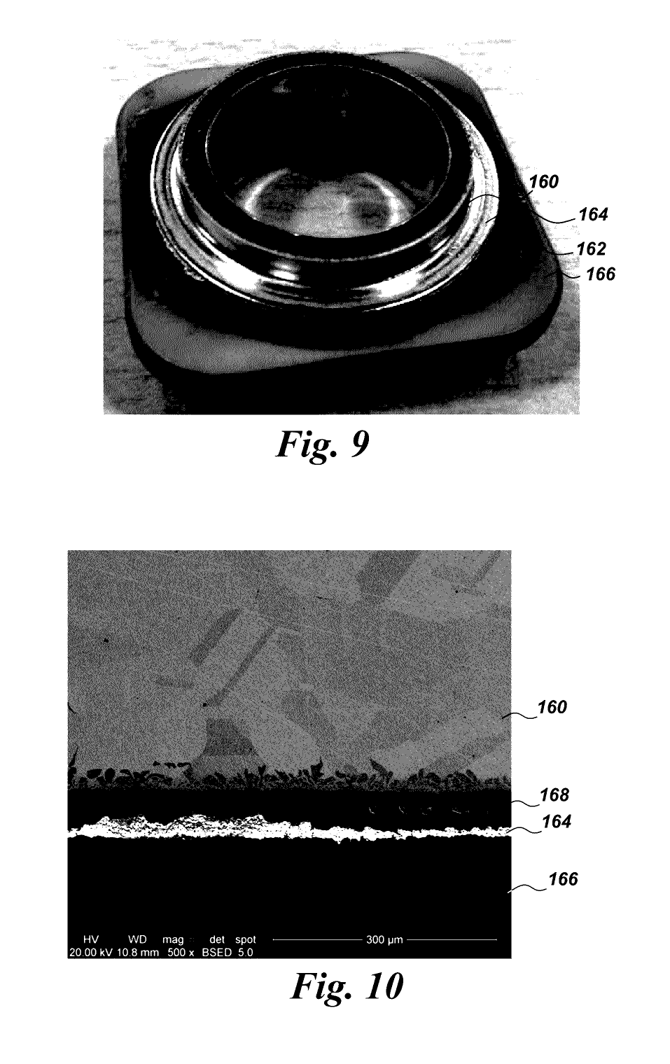

FIG. 9 is a photograph of a brazed structure, showing a ceramic-metal seal. Two nickel rings 160 and 162 are depicted in the figure. The rings were brazed to molybdenum layer 164, i.e., the metallization layer. The molybdenum layer has been applied to the alumina landing area 166 i.e., the flat part of the ring, using the high-velocity wire spray technique described previously. The braze alloy had the following composition: Ni-7Cr-4.5Si-3Fe-3.2B. Brazing was carried out in a vacuum, at 1055° C., for 15 minutes.

FIG. 10 is a cross-sectional scanning electron micrograph of a portion of the brazed structure of FIG. 5. The molybdenum layer 164 lies over alumina section 166, followed by braze layer 168. A section of nickel ring 160 is shown, attached to the braze layer. The overall structure provided a desirable, hermetic seal, with a helium leak rate of 1.0×10⁻¹⁰ cc/sec. An area immediately above the braze layer is a region which appears to show some intermetallic formation—probably in the form of borides or silicides from the braze. While the intermetallics are not ideal for good bond formation (it is usually preferred they not be present), the bond strength for the joint is still good in this instance. Moreover, there are techniques available for minimizing or eliminating the intermetallic formation.

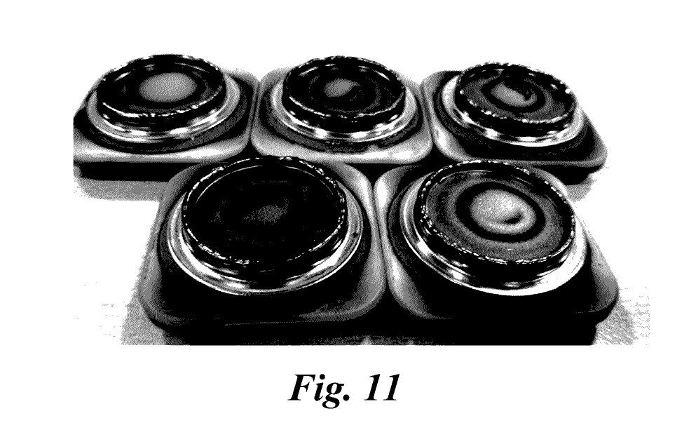

FIG. 11 is a photograph of a number of brazed structures, similar to those of FIG. 9. Five samples were tested for bond strength in the ceramic-to-metal joint (with the outer nickel ring), on a load-to-failure scale. The results are as follows.

TABLE 4

| Sample | Strength (N) |
|---|---|
| 1 | 1380 |
| 2 | 1350 |
| 3 | 1260 |
| 4 | 557 |
| 5 | 1300 |

The results generally demonstrate very good joint strength in the samples, with four of them being in the 1200N-1400N range. Sample 4 appeared to be an aberration, possibly due to variability in the molybdenum spray process; or the presence of dirt or impurities in one or more of the deposited layers.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed:

1) A method for joining a ceramic component to a metallic component, comprising the following steps:
a) applying at least one layer of molybdenum to a surface of the ceramic component, by a high-velocity molybdenum wire spray technique;
b) applying at least one layer of a nickel-based braze composition over the molybdenum layer; and
c) heating the braze composition to a sufficient brazing temperature, so as to provide a braze joint between them.

2) The method of claim 1, wherein the molybdenum wire spray technique comprises melting molybdenum wire by means of a combustion flame.

3) The method of claim 2, wherein the combustion flame is formed by the ignition of a gas mixture that comprises oxygen and at least one hydrocarbon gas.

4) The method of claim 2, wherein the hydrocarbon gas is selected from acetylene, propane, propylene, and liquefied petroleum gas (LPG).

5) The method of claim 2, wherein the temperature of the combustion flame is in the range of 2,600° C. to 4,000° C.

6) The method of claim 2, wherein the molybdenum wire has a diameter in the range of about 1 mm to 5 mm.

7) The method of claim 2, wherein the molybdenum wire is fed into the combustion flame at a feed rate in the range of 10 g/minute to 30 g/minute.

8) The method of claim 7, wherein the feed rate is adjusted in coordination with adjustment of the diameter of the molybdenum wire; and in coordination with adjustment of the combustion flame temperature used to melt the molybdenum wire; so as to provide a composition for the deposited layer of molybdenum that comprises about 10 wt % to about 30 wt % molybdenum oxides.

9) The method of claim 1, wherein the wire spray technique propels atomized, liquid droplets of molybdenum to the ceramic surface at a speed in the range of about 200 m/s to 800 m/s.

10) The method of claim 1, wherein the braze composition is applied over the molybdenum layer by a technique selected from electroplating, electroless plating, and screen-printing.

11) The method of claim 1, wherein a layer of nickel is applied over the layer of molybdenum, prior to application of the layer of the nickel-based braze composition.

12) The method of claim 11, wherein the layer of nickel is applied by a technique selected from electroplating, electroless plating, and screen-printing.

13) The method of claim 11, wherein the layer of nickel has a thickness in the range of 2 microns to 15 microns.

14) The method of claim 1, wherein the braze composition comprises at least about 30% by weight nickel.

15) The method of claim 1, wherein the braze composition further comprises at least one of silicon or boron.

16) The method of claim 1, wherein the ceramic component is an alpha-alumina structure; and the metallic component is a structure comprising at least one of nickel, niobium, molybdenum, iron, a nickel-cobalt ferrous alloy; mild steel, stainless steel, or tungsten, wherein both structures are incorporated into an electrochemical cell.

17) The method of claim 1, wherein the ceramic and metal components each comprise at least one thermal battery structure selected from the group consisting of electrode compartments; sealing collar structures, sealing ring structures, and electrical current collectors.

18) The method of claim 1, wherein the ceramic and metal components are structures joined together in a medical device.

19) The method of claim 18, wherein the medical device is an X-ray instrument.

20) The method of claim 1, wherein the ceramic and metal components are structures joined together in a drilling, pumping or motor device for oil or gas exploration.

21) A method of sealing an open region of a sodium metal halide-based battery that includes
(I) an anodic chamber for containing an anodic material; and a cathodic chamber for containing a cathodic material, separated from each other by an electrolyte separator tube, all contained within a case for the battery;
(II) an electrically insulating ceramic collar positioned at or near an opening of the cathodic chamber, and defining an aperture in communication with the opening; and
(III) a cathode current collector assembly disposed within the cathode chamber;
said method comprising the steps of
(i) inserting at least one metal ring between at least a portion of the cathode current collector assembly and an adjacent portion of the ceramic collar;
(ii) applying at least one layer of molybdenum to a surface of the ceramic collar, by a high-velocity molybdenum wire spray technique;
(iii) applying at least one layer of a nickel-based braze composition over the molybdenum layer; and
(iv) heating the braze composition to a sufficient brazing temperature, so as to provide, upon cooling, a hermetic seal between the metal ring, the current collector assembly, and the adjacent portion of the ceramic collar.
